(19) United States
(12) Patent Application Publication
(10) Pub. No.: US 2004/0217830 A1
(43) Pub. Date: Nov. 4, 2004

(54) RF multilayer circuit board

(76) Inventors: Thomas Hansen, Hildesheim (DE); Martin Schneider, Hildesheim (DE); Oliver Brueggemann, Ilsede (DE)

Correspondence Address: KENYON & KENYON, ONE BROADWAY, NEW YORK, NY, 10004, US

(21) Appl. No.: 10/776,147

(22) Filed: Feb. 10, 2004

(30) Foreign Application Priority Data
Feb. 13, 2003 (DE) 10305855.9

(51) Int. Cl. H01P 3/08

(52) U.S. Cl. 333/246

(57) ABSTRACT

An RF multilayer circuit board having: a first conductive device in a first plane for providing a first RF signal line; a first reference potential plane in a second plane for providing a reference potential of the first RF signal line; at least one second reference potential plane in a third plane for providing a reference potential of an at least one second RF signal line; at least one second conductive device in a fourth plane for providing a second RF signal line; a plated through hole device for electrically connecting the first and second conductive devices, the first and second reference potential planes each having a recess between them in the area of the plated through hole device; and at least one additional conductive device in the area of the plated through hole device at least between the first and second reference potential planes and bonding them in order to provide a waveguiding channel around the plated through hole device.

### FIELD OF THE INVENTION

The present invention relates to an RF multilayer circuit board and in particular a radio-frequency multilayer circuit board for use in RF sensor systems in motor vehicles.

### BACKGROUND INFORMATION

In the field of RF technology, in particular the area of mm-wave technology, planar circuits are preferably manufactured on softboard circuit boards or other very low-loss and close tolerance materials, which are, for example, Teflon-containing, optionally reinforced with glass fibers or provided with ceramics. In addition to their clear cost advantage, softboards are distinguished by low RF losses compared to other circuit boards; however, they have the disadvantage that their structure is very soft and has hardly any inherent strength. In practical use, these circuit boards are therefore applied to a very stable substrate such as the circuit board material FR4, for example.

The problematic lack of strength of a softboard is further aggravated because with increasing signal frequencies, increasingly thinner circuit boards or printed circuit boards must be selected so that the electromagnetic waves are guided interference-free, i.e., without excitation of higher modes, in the planar circuits. Due to the constantly advancing integration and miniaturization of electronic circuits, mm-wave circuits are also constructed on a plurality of layers or layers/planes. The consequence of this is that, for example, RF circuits are constructed on the front and back of a multilayer circuit board. If the two mm-wave-capable circuit boards are made of softboard material, a layer providing strength or structure made of FR4, for example, is also used to meet the electrical requirements, e.g., in radio relay technology, aerospace engineering, and automotive engineering. Implementing the mm-wave signals or interconnecting to other layer planes requires signal wiring devices adapted to mm-waves between the RF circuits on the RF layers to be connected.

A known electrical connection of two signal lines 10, 10′ of a planar mm-wave circuit on different planes or layers L1, L4 of a multilayer circuit board is shown in FIG. 7. The electrical connection is made using a plated through hole device 11 known as a via. To that end, via 11 must penetrate a reference potential plane 12, which separates the two line layers L1 and L4. In this area, a recess 13 is provided in reference potential plane 12 in order to avoid a short-circuit between signal lines 10, 10′ and reference potential plane 12.

FIG. 8 shows a signal connection between RF circuits (not shown) on different RF planes or layers L1 and L4 to be connected according to the related art. A plated through hole device 11 between a first signal line 10 of plane L1 and another signal line 10′ in plane L4 is provided through recesses 13, 13′ in a reference potential plane 12 and a second reference potential plane 12′, reference potential plane 12 being located in plane L2 and reference potential plane 12′ being located in plane L3. A plated through hole 11 or connection of this type between signal lines 10, 10′ has serious disadvantages in particular at higher frequencies in the GHz range. The mm-wave is irradiated from plated through hole device 11 or the signal via into a gap space between first and second reference potential plane 12, 12′, which is preferably designed as a stiffening layer. This means that components 15 of the RF waves become detached from signal-guiding via 11 into gap space 14. This is primarily expressed by greater losses in the signal path. Furthermore, irradiated component 15 results in couplings or interference with other RF signals, in particular to additional feedthroughs, which are of a similar design. Such couplings generally have a disadvantageous influence on the circuit behavior. Additional losses occur through dielectric losses in the material of the gap space and through reflection to the transition between the softboard and the material of gap space 14 due to a jump of relative dielectric constant εᵣ. Essential in this connection, however, are the losses that occur through irradiation into gap space 14.

### SUMMARY OF THE INVENTION

In contrast to the known approach to achieving the object, the RF multilayer circuit board of the present invention has the advantage that the losses described above are reduced by providing a waveguiding channel, preferably filled with stiffening material, similar to that of a coaxial cable, around the plated through hole device or the signal via in the area of the gap space.

This makes it possible for an mm-wave signal to be guided between the plated through hole device and the RF reference potential defined by the gap space. “Irradiation” into the gap space is thereby reduced.

An idea on which the present invention is based is essentially that, around the plated through hole device or signal via, additional conductive devices or vias are provided conductively with the reference potential planes and at least between them to define a waveguiding channel.

In other words, an RF multilayer circuit board is provided having: a first conductive device in a first plane for providing a first RF signal line; a first reference potential plane in a second plane for providing a reference potential of the first RF signal line; at least one second reference potential plane in a third plane for providing a reference potential of at least one second RF signal line; at least one second conductive device in a fourth plane for providing a second RF signal line; a plated through hole device for electrically connecting the first and second conductive devices, the first and second reference potential planes located between them each having a recess in the area of the plated through hole device; and at least one additional conductive device in the area of the plated through hole device at least between the first and second reference potential planes and bonding (contacting) them in order to provide a waveguiding channel around the plated through hole device.

The present invention makes it possible to bridge intermediate layers or gap spaces of almost any thickness, for example, stiffening layers, but also layers having other functions, e.g., voice frequency layers, without the mm-wave signal being substantially adversely affected by being irradiated into the gap space.

According to a preferred refinement, the additional conductive device extends between the first and second plane in the area of the first plated through hole device. This offers the advantage of simple, cost-effective manufacture using ground vias through the entire vertical multilayer structure.

According to another preferred refinement, in the area of the plated through hole device, the additional conductive device has a plurality of, in particular cylindrical, conductive vias which are essentially coaxial to the plated through hole device, and preferably form a semicircle of one or more rows. In order to further reduce the losses through irradiation into the gap space of the mm-wave, the additional conductive device may have not only one semicircular row of ground vias in the area of the plated through hole device but even a second or additional rows, additional costs of manufacturing due to the introduction of additional vias being almost negligible.

According to another preferred refinement, a dielectric material that stiffens the circuit board is provided between the first and second reference potential plane, the dielectric material preferably having a dielectric constant εᵣ, which corresponds to a softboard material in the area of the first and/or fourth plane. This has the advantage that losses due to reflection at the transition between the softboard material and the stiffening material are further minimized and the wave impedance is readily adapted.

According to another preferred refinement, a plurality of reference potential planes is provided between the first and second reference potential plane, which are preferably provided with recesses of varying size in the area of the plated through hole device. If the gap space between the first and second reference potential planes is built up in layers having corresponding ground planes, an additional loss reduction may be advantageously generated. Furthermore, recesses of varying size may be used as matching plates to minimize reflections within the system.

According to another preferred refinement, the additional conductive device in the area of the plated through hole device has a plurality of, preferably cylindrical, vias that form a ring around the plated through hole device. Such a closed ring advantageously makes it possible to further reduce the irradiation into the gap space.

According to another preferred refinement, a recess filled with a dielectric is provided between at least the first and second reference potential plane in the area of the plated through hole device, at least the wall having a conductive material in the area of the recess and forming the additional conductive device in the area of the plated through hole. Advantageously, a closed coaxial channel is thus formed between the reference potential planes of the mm-wave substrate, it also being possible in this manner to use a metal or another material, which may be metal plated, as a filler of the gap space between the reference potential planes.

According to another preferred refinement, a metal-plated, tubular device forms the additional conductive device in the area of the plated through hole device. In this manner, it is advantageously possible to introduce a cost-effective manufacture of a quasi-coaxial line in the area of the plated through hole device.

### BRIEF DESCRIPTION OF THE DRAWINGS

FIG. 1 shows a schematic, oblique view of an RF multilayer circuit board to elucidate a first embodiment of the present invention.

FIG. 2 shows a schematic, oblique view of an RF multilayer circuit board to elucidate a second embodiment of the present invention.

FIG. 3 shows a schematic, oblique view of an RF multilayer circuit board to elucidate a third embodiment of the present invention.

FIG. 4 shows a schematic, oblique view of an RF multilayer circuit board to elucidate a fourth embodiment of the present invention.

FIG. 5 shows a schematic, oblique view of an RF multilayer circuit board to elucidate a fifth embodiment of the present invention.

FIG. 6 shows a schematic, oblique view of an RF multilayer circuit board to elucidate a sixth embodiment of the present invention.

FIG. 7 shows a schematic, oblique view of a known plated through hole device.

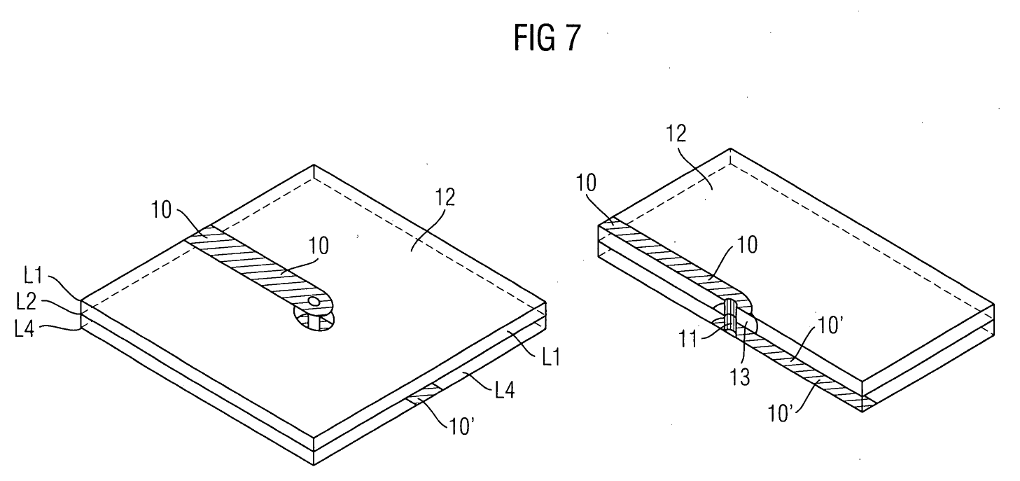

FIG. 8 shows a schematic, oblique view of a known RF multilayer circuit board.

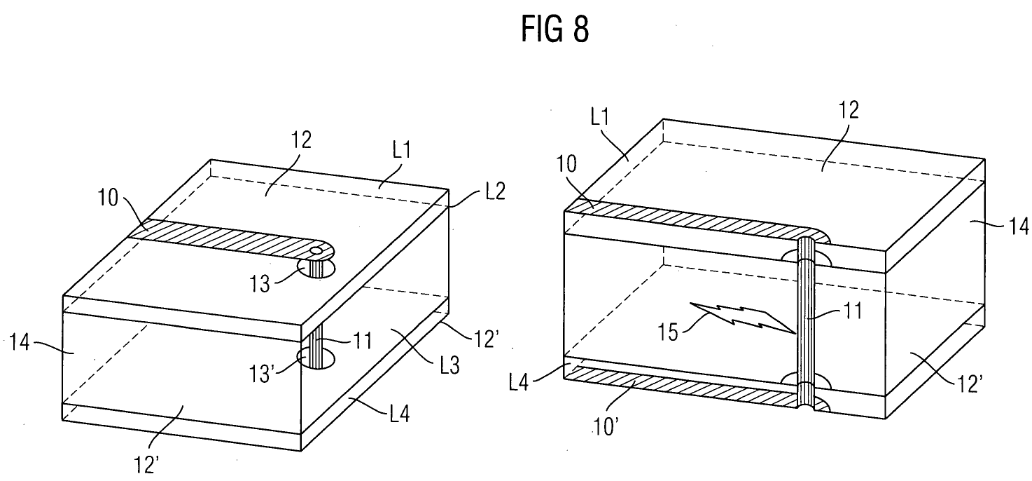

### DETAILED DESCRIPTION

Identical reference numerals in the figures denote identical components or components having identical functions.

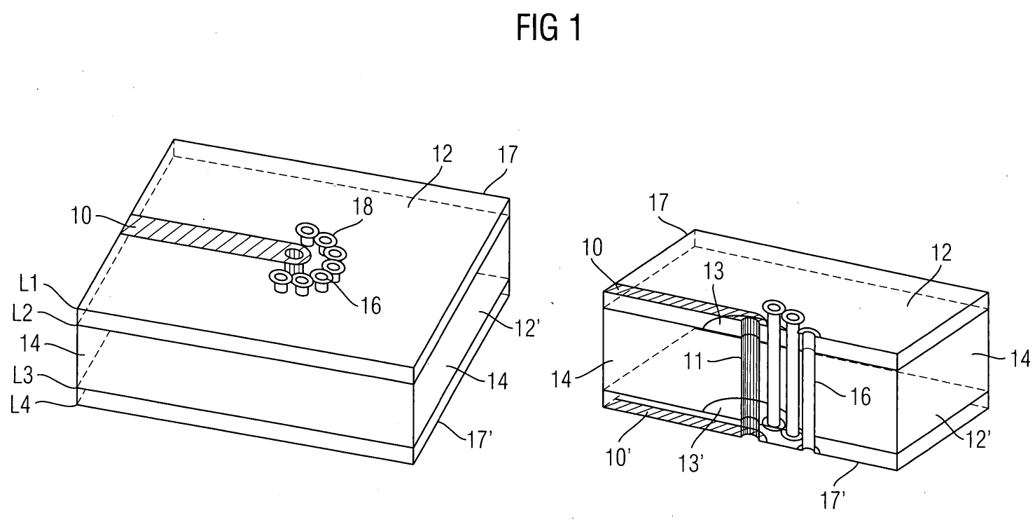

FIG. 1 shows an RF multilayer circuit board having a first conductive device 10, a signal line, for example, in a first plane L1. This signal line 10 of plane L1 is connected through a plated through hole device 11, preferably a cylindrical via, to a fourth plane L4, i.e., a second conductive device 10′, a signal line, for example. Essentially perpendicular plated through hole device 11 extends through a first reference potential plane 12, which is located on a second plane L2, and a second reference potential plane 12′, which is located on a third plane L3, preferably circular, recesses 13, 13′ being provided in each reference potential plane 12, 12′ in the area of plated through hole device 11. A gap space 14 is formed between first and second reference potential planes 12, 12′, gap space 14 preferably being filled with a stiffening material such as FR4, for example.

In this example, the section of a mm-wave circuit according to FIG. 1, which is distributed on two circuit boards 17, 17′ and is designed as a multilayer system, has four partially or completely metal plated planes L1, L2, L3, L4 and three dielectric planes, located between them. The mm-wave-capable circuit board material, preferably softboard material, lying between planes L1 and L2 and L3 and L4, respectively, has only a slight inherent stability, i.e., inherent stiffness. For that reason, the circuit boards are attached to a stiffening material in gap space 14. In order that the mm-wave of the signal on signal line 10, 10′ not be directly irradiated into gap space 14, at least one additional conductive device 16, also referred to as ground via in the following, is provided around plated through hole device 11. Additional conductive device 16 extends at least between first and second reference potential planes 12, 12′ and is connected to them in an electrically conductive manner.

The ground vias 16 positioned in a semicircle around one end of signal line 10, 10′ according to FIG. 1 in fact extend past reference potential planes 12, 12′ (L2, L3) to planes L1 and L4, which makes simpler, more cost-effective manufacture possible if ground vias 16 extend through the entire multilayer construction. Round metal surfaces 18 shown at the ends of ground vias 16 offer manufacturing advantages without, however, assuming a function according to the present invention. The mm-wave is guided through the ground vias 16 of additional conductive device 16 in a quasi-coaxial channel and is thus irradiated to a lesser extent into gap space 14 or the substrate material, which is preferably present there. In other words, this means that plated through hole device 11 and at least one ground via 16 form a separate conductor system, which is suitable for guiding mm-waves and prevents the wave from irradiating into gap space 14. Losses in the stiffening material of gap space 14 and by reflections at the transition of the mm-wave substrate, a softboard material, for example, between planes L1 and L2 or L3 and L4, to the stiffening material, which corresponds to a jump in the relative dielectric constant may be reduced by providing mm-wave-capable material having a low-loss factor for RF signals in the area of the quasi-coaxial channel of plated through hole device 11.

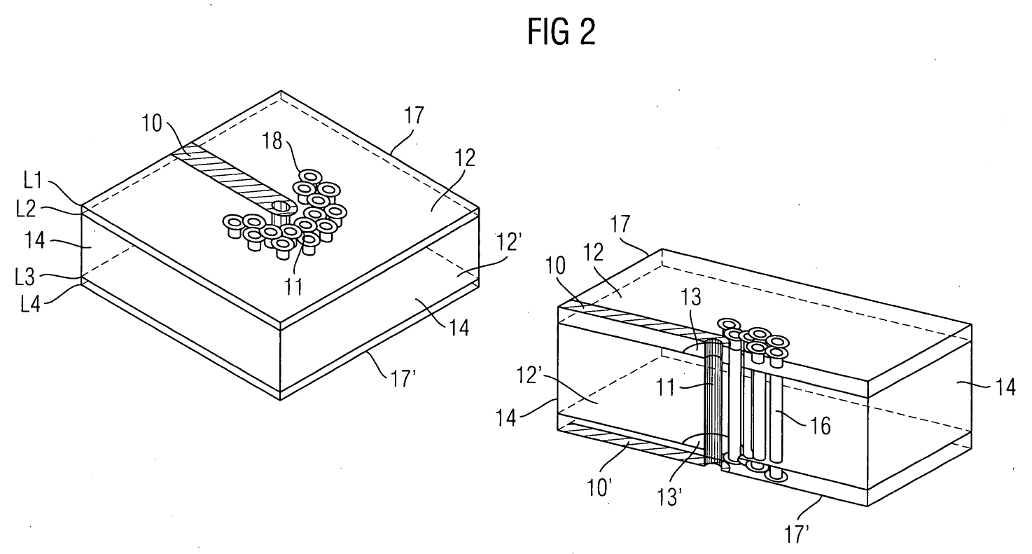

FIG. 2 shows another embodiment of an RF multilayer circuit board, which is essentially distinguished from the embodiment according to FIG. 1 in that a second row of ground vias 16 positioned in a semicircle is present to further reduce the losses by irradiation of a component of an mm-wave into gap space 14. Of course, even more than two rows of ground vias 16 are possible. Otherwise the embodiment of FIG. 2 is identical to that according to FIG. 1.

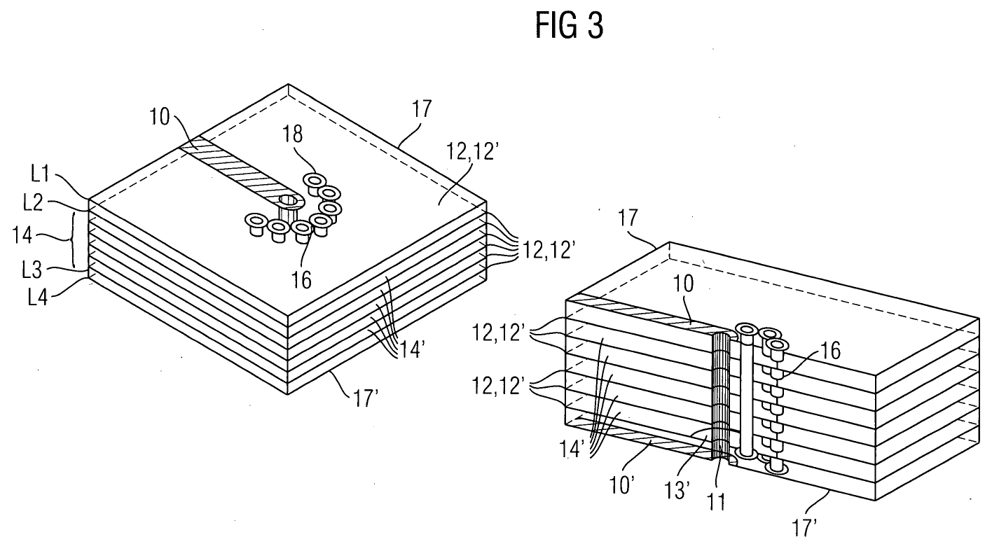

The embodiment according to FIG. 3 represents another variation of the embodiments according to FIG. 1 and FIG. 2. According to FIG. 3, gap space 14 between first reference potential plane 12 and second reference potential plane 12′ in plane L3 is shown with a plurality of reference potential planes 12′ parallel to each other, as a result of which a plurality of partial gap spaces 14′ preferably filled with a stiffening material is also provided. Reference potential planes 12, 12′ adjacent to partial gap spaces 14′ are provided with recesses 13′ in the area of plated through hole device 11, it being possible for these recesses 13, 13′ to be of different sizes and shapes in order to be used as matching plates for impedance transformation, for example, to minimize reflections within the system.

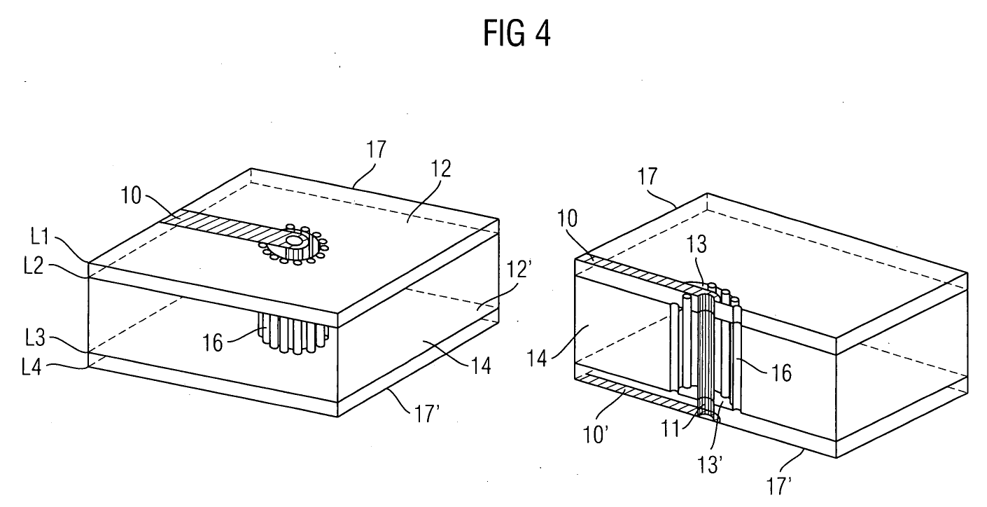

In the embodiment according to FIG. 4, the ground vias are positioned between both reference potential planes 12, 12′ having preferably circular recesses 13, 13′ for plated through hole device 11, and thus they only extend between planes L2 and L3. A closed ground via ring of a plurality of ground vias 16 made possible in this manner makes it further possible to reduce the irradiation of a signal on plated through hole device 11 into gap space 14

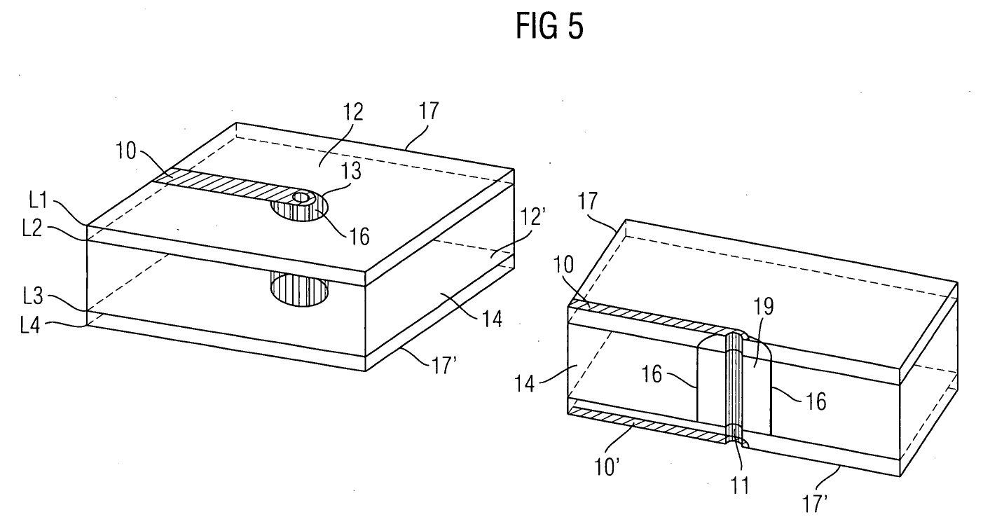

Another embodiment of an RF multilayer circuit board according to the present invention is shown in FIG. 5. mm-wave-capable plated through hole device 11 is shielded by a recess in the stiffening material in the gap space having a metal plated or conductive wall 16 as a ground via. For this preferably cylindrical recess provided by metal plating 16 between first and second reference potential plane 12, 12′, a dielectric material 19 is introduced. mm-wave signal lines 10, 10′ on substrates 17, 17′ are interconnected through the hole in the stiffening material of gap space 14 filled with dielectric 19 via a plated through hole device 11. In this embodiment, a closed coaxial channel is produced between reference potential surfaces 12, 12′ of mm-wave substrate 17, 17′. According to this embodiment, metal may also be used as a stiffening material in gap space 14 or any other material that may be provided with a metal plating which is used as ground via 16.

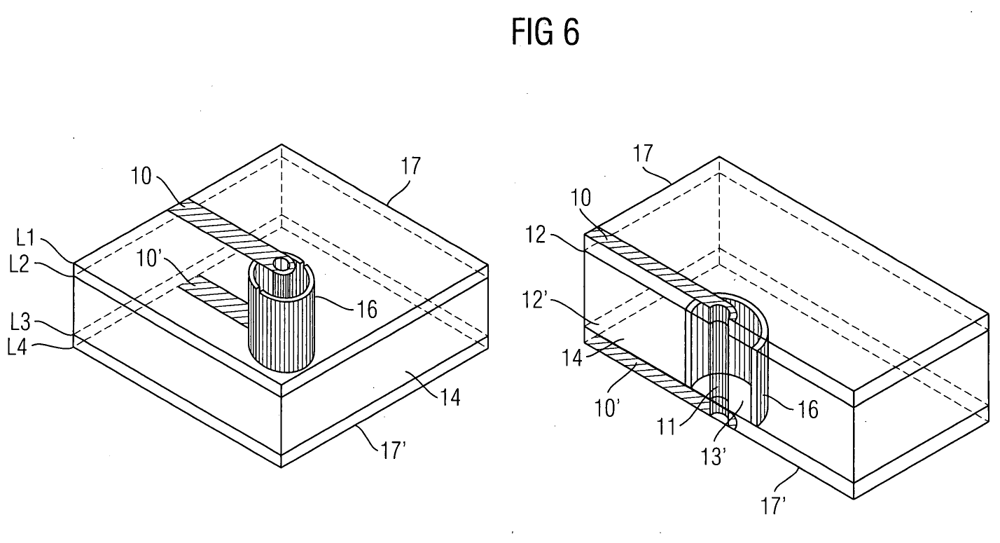

The RF multilayer circuit board according to FIG. 6 represents another embodiment of the present invention. A metal plated channel 16, which preferably forms a closed ring, is introduced into gap space 14 or the stiffening material present within it. Channel 16 connected to plated through hole device 11 between first and second reference potential planes 12, 12′ together with plated through hole device 11 forms a quasi-coaxial line, metal plated channel 16 or ring being made completely of metal or of a non-conductive material having a conductive plating.

Although the present invention was described on the basis of preferred exemplary embodiments, it is not limited to them but instead may be modified in various ways.

Thus a combination of different features of the different exemplary embodiments is possible in particular. Furthermore, a multilayer circuit board having more than only two RF layers 17, 17′ that are connected together is entirely possible.

What is claimed is:

1. An RF multilayer circuit board comprising:
a first conductive device in a first plane for providing a first RF signal line;
a first reference potential plane in a second plane for providing a reference potential of the first RF signal line;
at least one second reference potential plane in a third plane for providing a reference potential of an at least second RF signal line;
at least one second conductive device in a fourth plane for providing a second RF signal line;
a plated through hole device for electrically connecting the first and second conductive devices, the first and second reference potential planes between them each having a recess in an area of the plated through hole device; and
at least one additional conductive device in the area of the plated through hole device at least between the first and second reference potential planes and bonding them in order to provide a waveguiding channel around the plated through hole device.

2. The RF multilayer circuit board according to claim 1, wherein the additional conductive device extends between the first and fourth planes in the area of the plated through hole device.

3. The RF multilayer circuit board according to claim 1, wherein, in the area of the plated through hole device, the additional conductive device has a plurality of cylindrical, conductive vias that are substantially coaxial to the plated through hole device, the vias forming a semicircle of at least one row.

4. The RF multilayer circuit board according to claim 1, further comprising a dielectric material that stiffens the circuit board and is situated in a gap space between the first and second reference potential planes, the dielectric material having a dielectric constant εᵣ, which corresponds to that of a softboard material in an area of at least one of the first and fourth planes.

5. The RF multilayer circuit board according to claim 1, wherein situated between the first and second reference potential planes are a plurality of reference potential planes which have recesses of varying size in the area of the plated through hole device.

6. The RF multilayer circuit board according to claim 1, wherein the additional conductive device in the area of the plated through hole device has a plurality of cylindrical vias that form a ring around the plated through hole device.

7. The RF multilayer circuit board according to claim 1, wherein a recess filled with a dielectric is situated at least between the first and second reference potential planes in the area of the plated through hole device, a wall have a conductive material in an area of the recess and forming the additional conductive device in the area of the plated through hole device.

8. The RF multilayer circuit board according to claim 1, wherein a metal-plated, tubular device forms the additional conductive device in the area of the plated through hole device.

9. The RF multilayer circuit board according to claim 1, wherein a material having a low loss factor at high frequencies is situated in the area of the additional conductive device in the area of the plated through hole device.
